(19) United States
(12) Patent Application Publication
(10) Pub. No.: US 2025/0299386 A1
(43) Pub. Date: Sep. 25, 2025

(54) GENERATING A COMPUTED TOMOGRAPHY (CT) IMAGE AT A TARGET ENERGY FROM A SINGLE POLYCHROMATIC CT IMAGE

(71) Applicant: GE Precision Healthcare LLC, Waukesha, WI (US)

(72) Inventors: Veera Venkata Lakshmi Rajesh Langoju, Bangalore (IN); Utkarsh Agrawal, Tokyo (JP); Bipul Das, Chennai (IN); Kok Yen Tham, Tokyo (JP); Risa Shigemasa, Tokyo (JP); Yasuhiro Imai, Tokyo (JP)

(73) Assignee: GE Precision Healthcare LLC, Waukesha, WI (US)

(21) Appl. No.: 18/614,949

(22) Filed: Mar. 25, 2024

(51) Int. Cl. G06T 11/00; G06T 7/11

(52) U.S. Cl. CPC G06T 11/003; G06T 7/11; G06T 2211/40

(57) ABSTRACT

A computed tomography imaging system includes an X-ray source configured to emit X-ray radiation that traverses a subject being imaged, an X-ray controller configured to control an energy applied to the X-ray source, an X-ray radiation sensitive detector array disposed opposite the X-ray source, and configured to detect X-ray radiation traversing the subject, generating signals indicative of the detected X-ray radiation, a reconstructor configured to reconstruct an image based on the signals, wherein the image includes at least two material classes and corresponds to the applied energy, and an operator console with at least one processor configured to execute a target energy-image module to generate an output image at a target energy based on the reconstructed image, the applied energy, the target energy, and material class specific energy transformation models, including a different energy transformation model for each of the at least two material classes.

### FIELD

The following generally relates to computed tomography (CT) and more particularly to generating a CT image at a target energy from a single polychromatic CT image.

### BACKGROUND

A non-spectral computed tomography (CT) scanner generally includes a single broadband X-ray tube mounted on a rotatable gantry opposite one or more rows of detectors. The X-ray tube rotates around an examination region located between the X-ray tube and the one or more rows of detectors and emits polychromatic radiation that traverses the examination region. For example, with a peak tube voltage of 120 kVp, the energy spectrum of the emitted radiation (after filtering of low energy photons) may be from 40 keV to 120 keV. The one or more rows of detectors detect radiation that traverses the examination region and generate projection data (line integrals) indicative thereof. The projection data is reconstructed to generate volumetric image data. Generally, corrections (e.g., scatter correction, beam hardening correction) are applied during reconstruction.

The voxels of the reconstructed volumetric image data are displayed as two or three-dimensional images using gray scale values corresponding to relative radiodensity. The gray scale values reflect the attenuation characteristics of the scanned subject and generally show structure such as anatomical structures within the scanned subject. Since the attenuation of a photon by a material is dependent on the energy of the photon traversing the material, the detected radiation also includes spectral information, which provides additional information indicative of the elemental and/or material composition of the scanned material of the subject. However, the projection data does not reflect the spectral characteristics as the values of the projection data are proportional to the energy fluence integrated over the energy spectrum (e.g., 40 keV to 120 keV), and the volumetric image data does not reflect the energy dependent information.

A spectral (multi-energy) CT scanner is configured to generate projection data for different energy bands. With a dual energy kVp switching configuration, a first voltage (e.g., a lower kVp) is applied across the X-ray tube voltage for an integration period, a second voltage (e.g., a higher kVp) is applied across the X-ray tube voltage for a next integration period, and this alternating pattern of lower and second higher kVp is repeated for the scan. With a dual-energy two X-ray tube configuration, a lower kVp is applied across one X-ray tube and a higher kVp is applied across the other X-ray tube. With a dual-energy two detector layer configuration, one layer is configured to detect lower energy X-rays and the other configured to detect higher energy X-rays. With these examples, the lower and higher kV projection data can be decomposed into photoelectric effect and Compton scattering components, where the components are individually reconstructed and combined to produce monoenergetic volumetric image data (e.g., a 50 keV image, a 70 keV image, etc.).

Unfortunately, kVp switching circuitry, additional X-ray tubes and/or additional detector layers increase the overall cost of the imaging system, and the data acquisition and processing add complexity. An approach to generate a target energy image from a given input image includes using a global transformation between the given input image and the target energy image. However, every tissue type has a specific relational characteristic in the energy transformation process. Thus, such an approach tends to be sub-optimal and becomes a many-to-many mapping problem. Furthermore, as the difference between the energy level of the given input image and the energy level of the target image grows, the attenuation characteristics diverge significantly between organs such that a model cannot readily capture the varying non-linear attenuation characteristics of each tissue type.

In view of at least the foregoing, there is an unresolved need for an improved approach for generating a target energy image from a given input image.

### SUMMARY

Aspects described herein address the above-referenced problems and others. This summary introduces concepts that are described in more detail in the detailed description. It should not be used to identify essential features of the claimed subject matter, nor to limit the scope of the claimed subject matter.

In one aspect, a computed tomography imaging system includes an X-ray source configured to emit X-ray radiation that traverses a subject being imaged. The computed tomography imaging system further includes an X-ray controller configured to control an energy applied to the X-ray source. The computed tomography imaging system further includes an X-ray radiation sensitive detector array disposed opposite the X-ray source, and configured to detect X-ray radiation traversing the subject, generating signals indicative of the detected X-ray radiation. The computed tomography imaging system further includes a reconstructor configured to reconstruct an image based on the signals. The image includes at least two material classes and corresponds to the applied energy. The computed tomography imaging system further includes an operator console with at least one processor configured to execute a target energy-image module to generate an output image at a target energy based on the reconstructed image, the applied energy, the target energy, and material class specific energy transformation models, including a different energy transformation model for each of the at least two material classes.

In another aspect, a computer-implemented method includes obtaining a pair of different energy images acquired during a multi-energy image acquisition. The computer-implemented method further includes segmenting the plurality of different material classes from each of the pair of different energy images. The computer-implemented method further includes segmenting the two or more material sub-classes from the at least one of the materials. The computer-implemented method further includes determining a joint distribution for each of the two or more material sub-classes based on the pair of different energy images and the segmented two or more material sub-classes. The computer-implemented method further includes generating the different energy transformation model for each of the two or more material sub-classes based on corresponding joint distribution.

In another aspect, a computer readable medium is encoded with computer executable instructions. The computer executable instructions, when executed by at least one processor, cause the at least one processor to obtain an image acquired at a first energy in a single energy CT imaging examination, segment the image into at least two material classes, and generate an output image at a target energy for at least one of the two material classes based on an energy transformation model corresponding to the at least one of the two material classes.

Those skilled in the art will recognize still other aspects of the present application upon reading and understanding the attached description.

### BRIEF DESCRIPTION OF THE DRAWINGS

The application is illustrated by way of example and not limited by the figures of the accompanying drawings in which like references indicate similar elements.

FIG. 1 schematically illustrates a non-limiting example of an imaging system with a target energy-image module, in accordance with an embodiment(s) herein.

FIG. 2 schematically illustrates a non-limiting example of the target energy-image module, in accordance with an embodiment(s) herein.

FIG. 3 schematically illustrates a non-limiting example of a processing pipeline for the target energy-image module, in accordance with an embodiment(s) herein.

FIG. 4 schematically illustrates a variation of the target energy-image module, in accordance with an embodiment(s) herein.

FIG. 5 schematically illustrates a variation in which the target energy-image module is located in a PACS, in accordance with an embodiment(s) herein.

FIG. 6 schematically illustrates a variation in which a segmentation module is located in a remote resource, in accordance with an embodiment(s) herein.

FIG. 7 schematically illustrates a variation in which the target energy-image module is located in a remote resource, in accordance with an embodiment(s) herein.

FIG. 8 schematically illustrates a non-limiting example of an energy transformation generating model, in accordance with an embodiment(s) herein.

FIG. 9 graphically illustrates non-limiting distributions for generating transformation models for multiple material classes from a pair of two different energy images, in accordance with an embodiment(s) herein.

FIG. 10 graphically illustrates a single distribution for generating a prior art global transformation model for multiple material classes, in accordance with an embodiment(s) herein.

FIG. 11 graphically illustrates a joint distribution for a single material class having material sub-classes for a pair of energy images, in accordance with an embodiment(s) herein.

FIG. 12 graphically illustrates joint distributions for the material sub-classes of FIG. 11 for a set of pair of energy images, in accordance with an embodiment(s) herein.

FIG. 13 graphically illustrates an example of joint distributions for different contrast phases of a single material class, in accordance with an embodiment(s) herein.

FIG. 14 graphically illustrates another example of joint distributions for different contrast phases of a single material class, in accordance with an embodiment(s) herein.

FIG. 15 graphically illustrates an example of a joint distribution for a single contrast phase from a plurality of imaging examinations, in accordance with an embodiment(s) herein.

FIG. 16 schematically illustrates a variation that includes a deep learning algorithm, in accordance with an embodiment(s) herein.

FIG. 17 illustrates a non-limiting example of a flow chart for a computer-implemented method for generating energy transformation models for different material classes, in accordance with an embodiment(s) herein.

FIG. 18 illustrates a non-limiting example of a flow chart for a computer-implemented method for generating energy transformation models for different material classes and material sub-classes, in accordance with an embodiment(s) herein.

FIG. 19 illustrates a non-limiting example of a flow chart for a computer-implemented method for generating energy transformation models for different contrast phases of a material class, in accordance with an embodiment(s) herein.

FIG. 20 illustrates another non-limiting example of a flow chart for a computer-implemented method for employing energy transformation models for different material classes, in accordance with an embodiment(s) herein.

FIG. 21 illustrates yet another non-limiting example of a flow chart for a computer-implemented method for employing energy transformation models for different material classes and material sub-classes, in accordance with an embodiment(s) herein.

FIG. 22 illustrates still another non-limiting example of a flow chart for a computer-implemented method for employing energy transformation models for different contrast phases of a material classes, in accordance with an embodiment(s) herein.

### DETAILED DESCRIPTION

Embodiments of the present disclosure will now be described, by way of example, with reference to the Figures, in which a system, a computer-implemented method, and/or computer executable instructions encoded on a computer readable medium generate a target energy image from an input image acquired at a single energy based on energy material class/sub-class specific energy transformation models, which are functions of the material class/sub-class, acquisition energy, and contrast phase, by transforming attenuation values (CT numbers) of the input image to attenuation values corresponding to the target energy. In one instance, the energy transformation models are generated by learning material attenuation relations between pairs of different energy images for material classes such as organs, material sub-classes such as anatomical structures within an organ, contrast phases for a material class, etc. In one instance, this approach considers that different material classes/sub-classes have different relational characteristics in the energy transformation process (e.g., due to the varying non-linear attenuation characteristics of each material class) and can mitigate shortcomings with a transformation that does not consider such characteristics. In one instance, the approach can be considered an attenuation physics driven model for generating a target energy image from a single energy CT image that is equivalent to a dual energy CT image.

As utilized herein, energy refers to kVp of a polychromatic/polyenergetic imaging acquisition or image data and/or KeV of monochromatic/monoenergetic image data. An image or image data includes two-dimensional (2-D) slices (e.g., axial, sagittal, coronal, oblique, etc.) and/or three-dimensional (3-D) volumes. A material class includes an anatomical tissue class (e.g., fat, lung, heart, etc.) as well as a non-tissue class (e.g., air, an implant, etc.). A material sub-class includes anatomical structure within an anatomical tissue class (e.g., vessels and parenchyma in the liver). Contrast phases (i.e., stages of contrast agent enhancement following an intravenously (IV) administered contrast agent) include a pre- or non-contrast phase, an early arterial phase (also known as CTA), a late arterial phase (also known as arterial), a portal venous phase, a nephrogenic phase and/or an excretory phase (also known as delayed). A CT number is a quantitative value in Hounsfield units and represents radiodensity.

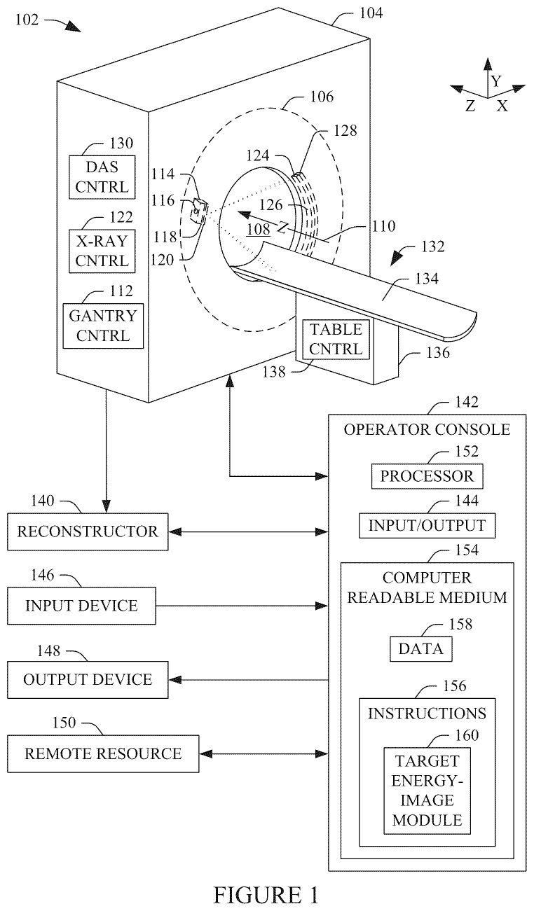

Initially referring to FIG. 1, a non-limiting example of an imaging system 102 such as a computed tomography (CT) imaging system is schematically illustrated. The imaging system 102 includes a generally stationary (i.e. non-rotating) gantry 104 and a rotating frame 106. The rotating frame 106 is rotatably supported by the stationary gantry 104, e.g., via a bearing or the like, and is configured to rotate around an examination region 108 about a rotational or z-axis 110. In some instances, the stationary gantry 104 can be configured to tilt through the z-axis 110. A gantry controller (GANTRY CNTRL) 112 is configured to control rotation (and tilt, if available) of the rotating frame 106, including no rotation.

An X-ray source assembly 114 is supported by the rotating frame 106 and rotates in coordination with the rotating frame 106. The X-ray source assembly 114 includes an X-ray source 116 such as an X-ray tube. The X-ray source 116 is configured to emit polychromatic X-ray radiation having an energy in the diagnostic range (e.g., 20 keV to 150 keV). The X-ray assembly 114 may further include or is coupled to a filter 118 that characterizes a radiation dose profile and/or a collimator 120 that shapes the X-ray radiation to form a generally fan, wedge, cone, etc. shaped beam that traverses the examination region 108. An X-ray controller (X-RAY CNTRL) 122 is configured to control components of the X-ray assembly 114 such as radiation emission of the X-ray source 116, the collimator 120, etc.

A radiation sensitive detector array 124 includes a one- or two-dimensional (1-D or 2-D) array of rows of radiation sensitive detector elements 126 and is supported by the rotating frame 106 along an arc opposite the X-ray source 116, across the examination region 108. Each radiation sensitive detector element of the array of rows of radiation sensitive detector elements 126 is in electrical communication with data acquisition electronics 128. A data acquisition electronics controller (DAS CNTRL) 130 controls the data acquisition electronics 128.

A subject/object support 132 includes a tabletop 134 moveably coupled to a frame/base 136. In one instance, the tabletop 134 is slidably coupled to the frame/base 136 via a bearing or the like, and a drive system (not visible) including a controller, a motor, a lead screw, and a nut (or other drive system) translates the tabletop 134 along the frame/base 136 into and out of the examination region 108. The tabletop 134 is configured to support an object or subject in the examination region 108 for loading, scanning, and/or unloading the subject or object. A table controller (TABLE CNTRL) 138 controls the drive system.

For a helical scan, the rotating frame 106 rotates in coordination with the tabletop 134 moving along the Z-axis 110, and active detector elements 126 of the radiation sensitive detector 124 detect radiation over consecutive arc segments (integration periods) each revolution and generate respective signals. For an axial (step and shoot) scan, the tabletop 134 is positioned at a static position for each integration period and moves between integration periods. For each arc segment, the data acquisition electronics 128 processes each signal and generates projection data.

A reconstructor 140 reconstructs the projection data and generates volumetric (3-D) image data for a helical scan and/or individual axial (2-D) images for an axial step and shoot scan (which can be used in combination to generate volumetric image data). The volumetric image data and/or 2-D slices thereof, and/or the individual axial images can be visually presented, filmed, etc. Examples of suitable reconstruction algorithms include filtered back projection (FBP), advanced statistical iterative reconstruction (ASIR), conjugate gradient (CG), maximum likelihood expectation maximization (MLEM), model-based iterative reconstruction (MBIR), and/or other reconstruction algorithm.

A computing system 142 serves as an operator console of the system 102. The computing system 142 may include a computer, a workstation, etc. The computing system 142 includes input/output (I/O) 144. An input device 146 includes a keyboard, mouse, touchscreen, microphone, etc. The input device 146 is in electrical communication with the computing system 142 through the I/O 144. An output device 148 includes a human readable device such as a display monitor or the like. The output device 148 is in electrical communication with the computing system 142 through the I/O 144.

A remote resource 150 includes one or more of a server, a workstation, a Radiology Information System (RIS), a Hospital Information System (HIS), an electronic medical record (EMR), a Picture Archiving and Communications System (PACS), one or more other CT scanners, cloud processing resources (which includes shared remote data storage and/or computing power, including processing resources distributed over multiple locations/data centers), etc. The remote resource 150 is in electrical communication with the computing system 142 through the I/O 144.

The computing system 142 further includes at least one processor 152 such as a microprocessor (μP), a central processing unit (CPU), graphics processing unit (GPU), etc., and computer readable medium 154, which includes non-transitory medium and excludes transitory medium (signals, carrier waves, and the like). The computer readable medium 154 is embedded or encoded with computer executable instructions/computer code (instructions) 156. The at least one processor 152 is configured to execute the computer executable instructions 156. The computer readable medium 154 is further configured to store data 158. The at least one processor 152 can utilize and/or store the data 158.

The computer executable instructions 156 include a target energy-image module 160. As described in greater detail below, the target energy image module 160 is configured to generate a target energy image from an input image acquired at a single energy based on energy material class/sub-class specific energy transformation models. The energy transformation models include models that are a function of material class/sub-class, acquisition energy, and contrast phase (which includes no contrast). The energy transformation models transform attenuation values of the input image to attenuation values corresponding to the target energy. In one instance, the energy transformation models are independent of scan parameters such as milliamperes (mA) level, mA modulation, rotation time, helical pitch, etc. Also described in greater detail below, the energy transformation models are generated by learning material attenuation relations between pairs of different energy images for material classes such as organs, material sub-classes such as anatomical structures within an organ, contrast phases for a material class, etc.

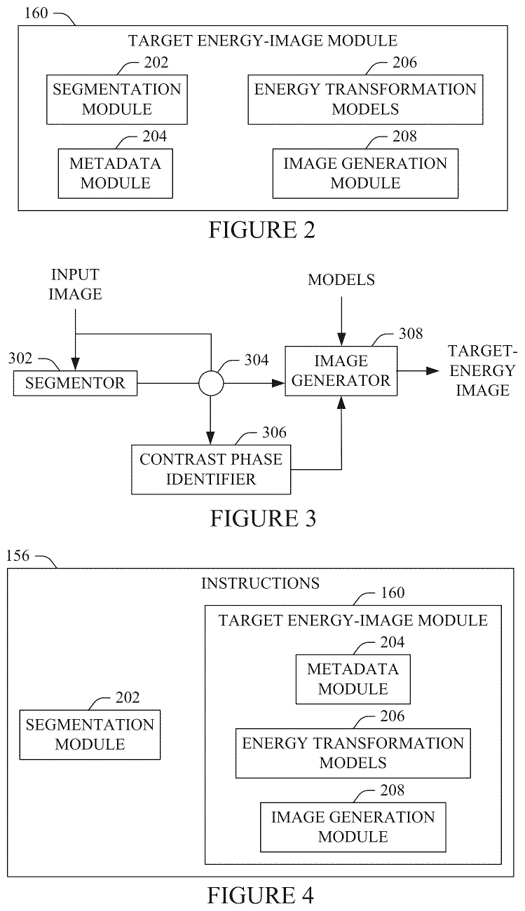

FIG. 2 schematically illustrates a non-limiting example of the target energy-image module 160. The target energy-image module 160 receives, as input, an image corresponding to an acquisition energy and outputs an image corresponding to a target energy, which is different than the acquisition energy. By way of non-limiting example, the input image may be an 120 kVp image from a 120 kVp scan and the target image may be a 50 keV image. As such, the approach described can generate target energy image from a single energy CT image, providing different energy images similar to a dual energy CT scanner. The target energy image module 160 includes a segmentation module 202, a metadata module 204, energy transformation models 206, and an image generation module 208.

The segmentation module 202 includes at least an image segmentation algorithm for segmenting material classes in an image. Material classes include anatomical tissue (e.g., an organ, parts of an organ, fat, etc.) as well as non-anatomical tissue such as air, etc. In another instance, the at least one image segmentation algorithm and/or a different segmentation algorithm is configured to segment material sub-classes within one or more material classes. Additionally, or alternatively, the at least one image segmentation algorithm and/or a different segmentation algorithm is configured to segment contrast phases within one or more material classes.

The image segmentation algorithm may include manual, semi-automatic and/or automatic segmentation approaches. The input image is the acquisition image, which can be obtained from the reconstructor 140 (FIG. 1), the computing system 142 (FIG. 1), and/or storage of the remote resource 150 (FIG. 1). The output is an image is a mask with labels identifying different material classes/sub-class in the input image based on a set of classes of interest. For example, in one instance the image mask is configured to identify up to thirty-six (36) different material classes such as air, fat, blood vessel, bone, kidney, liver, lung, pancreas, vertebrae, etc. In other instances, more or less material classes are identified.

In one instance, the segmentation module 202 utilizes an open source segmentation tool such as the “TotalSegmentator,” which was created by the department of Research and Analysis, Universitätsspital Basel, Petersgraben 4, 4031 Basel, and is described in Wasserthal, et. al., “TotalSegmentator: Robust Segmentation of 104 Anatomic Structures in CT Images,” Radiology: Artificial Intelligence, Vol. 5, No. 5, Jul. 5, 2023. The “TotalSegmentator” is tool trained on a wide range of different CT images (different scanners, institutions, protocols, etc.) for segmentation of over one hundred-seventeen (117) classes in CT images. The “TotalSegmentator” can be downloaded and installed on the computing system 142 (FIG. 1) and/or accessed online over the Internet at totalsegmentator.com.

Another non-limiting approach includes K-means clustering. With this approach, K cluster centers are selected randomly or based on a heuristic approach, each pixel in the image is assigned to a cluster that minimizes a distance between the pixel and the cluster center, the cluster centers are then re-computed by averaging all of the pixels in the cluster, and the assigning and re-computing steps are repeated until stopping criteria (e.g., convergence where no pixels change clusters) is reached. K can be selected manually, randomly and/or by a heuristic, the distance is a squared or absolute difference between a pixel and a cluster center, and the difference can be based on pixel color, intensity, texture, and location, or a weighted combination thereof.

Another non-limiting approach includes a histogram-based approach, where a histogram is computed from the pixels in the image and the peaks and valleys in the histogram are used to locate clusters in the image via color or intensity. Another non-limiting approach includes edge detection such as search, zero-crossing and/or other edge detection techniques that find edges. Another non-limiting approach includes thresholding, which employs a threshold value(s) to turn a gray-scale image into a binary image. Another non-limiting approach includes artificial intelligence approach (e.g., pulse-coupled neural networks, U-Net, etc.). Another non-limiting approach includes a region-growing approach. Other segmentation approaches are also contemplated herein.

The metadata module 204 is configured to obtain data that provides information about the input image, i.e., metadata. An example of such data includes the kVp of the imaging acquisition that acquired the project data for the input image. Another example of such data includes whether the imaging acquisition was a contrast-agent enhanced imaging acquisition. Another example of such data includes an indication of the anatomy in the input image. Another example of such data includes the target energy for the output target image. Other information is also contemplated herein. Such data can be retrieved, received, predicted, estimated, and/or otherwise obtained.

For example, in one instance at least a sub-set of such data is obtained from the input image, e.g., a header of the image file, such as a field of a header of a Digital Imaging and Communications in Medicine (DICOM) file. Additionally, or alternatively, at least a sub-set of such data is received as a user input via the input device 146 (FIG. 1), from a default file that includes hospital, imaging center, reading radiologist, etc. preferences, predicted using artificial intelligence (e.g., machine learning, neural networks, etc.) trained to predict and/or estimate such information based on the input image, hospital, imaging center, reading radiologist, etc., and/or otherwise.

The energy transformation models 206 include a set of energy transformations that can be applied to the input image to generate an output image for a target energy. For example, in one instance the set of transformations includes transformations to generate a X keV target image from an input Y kVp (or keV equivalent) acquisition image, where X+Y (e.g., a 50 keV image from a 120 kVp image or 70 keV image). In this example, the transformation employed for pixels corresponding to a particular material class are a function of at least the energy of the input image, the target energy, and the material class/sub-class. For input images acquired during a contrast-agent enhanced imaging acquisition, the energy transformation model is further a function of the contrast phase.

For example, the transformation for pixels in the input image corresponding to liver tissue will be a function of the energy of the input image, the target energy of the output image, and the attenuation characteristics of liver tissue, while the transformation for pixels in the input image corresponding to stomach tissue will be a function of the energy of the input image, the target energy of the output image, and the attenuation characteristics of stomach tissue. In another example, the transformation for pixels in the input image corresponding to contrast-agent enhanced blood vessel will be a function of the energy of the input image, the target energy of the output image, the attenuation characteristics of liver tissue, and the any contrast phase captured in the acquisition.

The image generation module 208 is configured to generate the output image at the given target energy based on the input image and a set of the energy transformation models 206, which correspond to the energy of the acquisition of the input image, the target energy, the tissue classes in the input image, and the contrast phase(s) in the input image (including no contrast). In one instance, the image generation module 208 generate a single output image for a single target energy. For instance, for an X kVp input image and a target energy of Y keV, the image generation module 208 generates an output image at the target energy of Y keV. In this instance, the imaging system 102, provides dual energy images, i.e., the input kVp and the output keV image.

In general, where there are N (where N is a positive integer equal to or greater than two) target energies, the image generation module 208 can generate an output image for each of the target energies based on the input image and corresponding transformations of the energy transformation models 206. Thus, for an X kVp input image and target energies of Y₀, . . . , Yᵢ, . . . , Y_{N} keV, the image generation module 208 generates an output image at each of the target energies of Y₀, . . . , Yᵢ, . . . , Y_{N} keV using corresponding transformations of the energy transformation models 206. In another instance, the image generation module 208 generates a single output image using energy transformations corresponding to different target energies, e.g., to generate pixels for different material classes based on different radiographic contrasts for the material classes in a single image.

Turning to FIG. 3, a non-limiting example of a processing pipeline for the target energy-image module 160 is schematically illustrated. The input image is provided to and processed by a segmentor 302, which can be implemented by the tissue segmentation module 202 (FIG. 2) and/or otherwise. The segmentor 302 outputs a segmented image/mask, e.g., as described in connection with FIG. 2 and/or otherwise. An operator 304 receives the input image and the segmented image/mask as operands to a predetermined operation/function and produces an operated on/reference image.

A contrast phase identifier 306 identifies contrast phases based on the reference image output by the operator 304. In one instance, this includes visually presenting the reference image via a human readable display of the output device 148 (FIG. 1) and/or other display, where a clinician, via the input device 146 (FIG. 1), provides input that estimates a contrast phase for one or more material classes of the reference image output by the operator 304. In another instance, an automatic or semi-automatic approach is utilized to identify contrast phase. For example, trained artificial intelligence such as a classifier trained to identify contrast phase in CT images can be utilized to identify contrast phase.

The reference image output by the operator 304 and any identified contrast phase are provided to the image generator 308, which can be implemented by the image generation module 208 (FIG. 2) and/or otherwise. The image generator 308 obtains, for the material classes in the reference image output by the operator 304, corresponding energy transformation models from the energy transformation models 206, which are based on the energy of the input image, the target energy of the output image, the tissue classes, and any identified contrast phase. The image generator 308 applies the transformation models and outputs the target energy image.

Moving to FIGS. 4, 5, 6 and 7, variations of the example described in connection with FIG. 2 are schematically illustrated. In FIG. 2, the target energy-image module 160 includes the tissue segmentation module 202, the metadata module 204, the energy transformation models 206, and the image generation module 208. In FIG. 4, the tissue segmentation module 202, the metadata module 204, the energy transformation models 206, and the image generation module 208 are still part of the instructions 156, however, the tissue segmentation module 202 is not part of the target energy-image module 160.

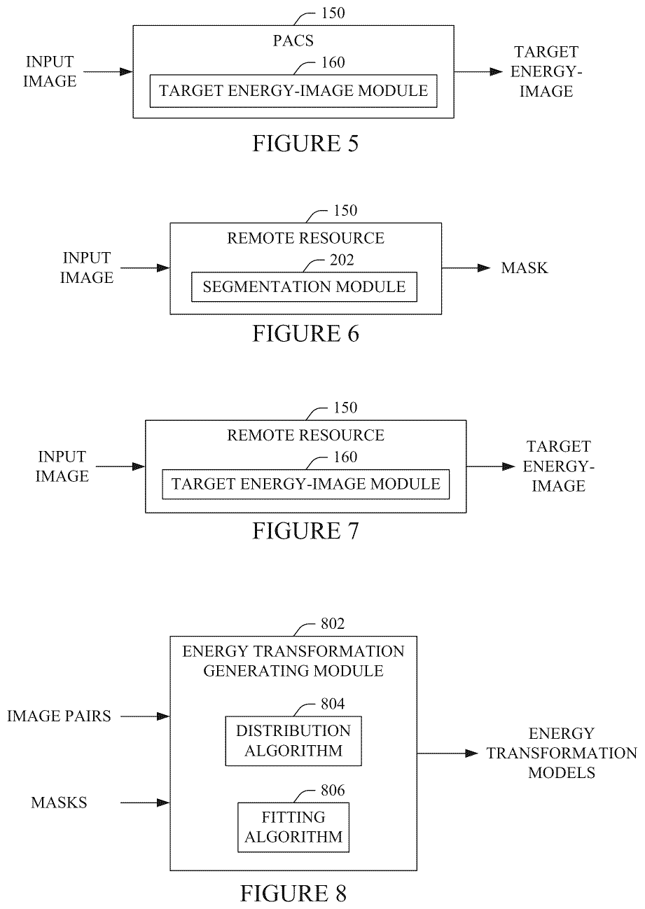

In FIG. 5, the remote resource 150 includes a picture archiving and communication system (PACS). Generally, a PACS is a specialized computing system configured for storing, viewing and/or manipulating medical images, such as CT images. Digital images are electronically transferred to a PACS via protocols such as DICOM over a secured network. Non-image data, such as scanned documents, may be incorporated using standard formats such as Portable Document Format (PDF) and/or other formats.

The input image can be provided by the operator console 142 (FIG. 1) and/or from another resource of the remote resource 150 such as a RIS, a HIS, an EMR, a cloud based service, and/or other computing system. The target energy-image module 160 processes the input image and generates the output target energy-image as described herein and/or otherwise. The output target energy-image can be provided to the operator console 142 (FIG. 1) and/or another resource of the remote resource 150 such as a RIS, a HIS, an EMR, a cloud based service, and/or other computing system.

In FIG. 6, the remote resource 150 includes the segmentation module 202. With this variation, the input image is transmitted to the remote resource 150, where the material class mask is generated by the segmentation module 202. The input image can be provided by the operator console 142 (FIG. 1) and/or from another resource of the remote resource 150 such as a RIS, a HIS, an EMR, a cloud based service, a PACS, and/or other computing system. The mask can be provided to the operator console 142 (FIG. 1) and/or another resource of the remote resource 150 such as a RIS, a HIS, an EMR, a cloud based service, a PACS, and/or other computing system.

In FIG. 7, the remote resource 150 can be a workstation, a server, a cloud service, another imaging system, etc. that includes the target energy-image module 160. With this variation, the input image is transmitted to the remote resource 150, where the target energy-image module 160 processes the input image and generates the output target energy image as described herein and/or otherwise. The input image can be provided by the operator console 142 (FIG. 1) and/or from another resource of the remote resource 150 such as a RIS, a HIS, an EMR, a cloud based service, a PACS, and/or other storage. The output target energy image can be provided to the operator console 142 (FIG. 1) and/or another resource of the remote resource 150 such as a RIS, a HIS, an EMR, a cloud based service, a PACS, and/or other storage.

Turning to FIG. 8, an example energy transformation generating module 802 is schematically illustrated. The energy transformation generating module 802 receives, as input, pairs of different energy images. In one instance, the pairs of energy images are generated by a spectral (multi-energy) CT scanner, e.g., a scanner configured with kVp switching, two or more X-ray tubes, and/or two or more detector layers, as discussed herein. In yet another instance, two broadband (polychromatic) images of the same anatomy but with different kVp settings can be acquired (e.g., 80 kVp and 140 kVp), e.g., during consecutive acquisitions of a same imaging examination.

The energy transformation generating module 802 further receives, as input, a segmentation mask corresponding to each of the pairs of different energy images. The pairs of different energy images can be segmented, e.g., as described in connection with FIG. 2 and/or otherwise, based on a predetermined set of material classes, and, optionally, material sub-classes. In general, a material at an x,y or x,y,z location in one of the images of the image pair is the same material as a material at the same x,y or x,y,z location in the other image of the image pair. The difference between the CT numbers of the two locations is a function the different energies of the two images and the different attenuation characteristics of the material classes for the different energies.

A distribution algorithm 804 is configured to determine joint distributions based on the pairs of energy images and corresponding segmentation masks. In one instance, the distribution algorithm 804 generates two or more joint distributions for two or more of the material classes segmented from the pairs of energy images. Alternatively, or additionally, the distribution algorithm 804 generates two or more joint distributions for material sub-classes of a material class. Alternatively, or additionally, the distribution algorithm 804 generates two or more joint distributions for two or more contrast phases of a material class and/or sub-class.

A fitting algorithm 806 is configured to fit a curve to each distribution generated by the distribution algorithm 804 to create an energy transformation model based on each distribution. As such, in one instance an energy transformation model is configured to map a pixel value corresponding to a particular material class for an energy of an input image to a different pixel value corresponding to the particular material class for a target energy of a generated output image. In another instance, the energy transformation model is configured to map a pixel value corresponding to a particular material sub-class of a particular material class for an energy of an input image to a different pixel value corresponding to the material sub-class for a target energy of a generated output image. In another instance, the energy transformation model is configured to map a pixel value corresponding to a particular contrast phase of a particular material class for an energy of an input image to a different pixel value corresponding to the particular contrast phase and the particular material class for a target energy of a generated output image.

The distributions and/or the energy transformation models can be stored, e.g., in storage of the operator console 142, the remote device 150, etc. In one instance, the energy transformation models are stored in a data structure, a database, etc. Table 1 below shows a list of non-limiting example of a sub-set of energy transformation models. A first group of rows identify energy transformation models for n different material classes to generate a Y energy image from an X energy image. A next group of rows identify energy transformation models for m different material sub-classes for an ith material class to generate a Y energy image from an X energy image. A subsequent group of rows identify energy transformation models for k different contrast phases for a jth material class to generate a Y energy image from an X energy image. In Table 1, n, i, j, m, and k are positive integers representing indices.

TABLE 1
Examples list of energy transformation models.

| Model | Input Image | Target Image | Material | Material | Contrast |
|---|---|---|---|---|---|
| Identifier | Energy | Energy | Class | Sub-Class | Phase |
| MC₀ | X | Y | 1 | | |

.
.
.
.
.
.

| | | | | |
|---|---|---|---|---|
| MC₍ₙ₋₁₎ | X | Y | n | |
| SC₀ | X | Y | i | 1 |

.
.
.

| | | | |
|---|---|---|---|
| SC₍ₘ₋₁₎ | X | Y | m |

.
.
.

| | | | | |
|---|---|---|---|---|
| CP₀ | X | Y | j | 1 |

.
.
.

| | |
|---|---|
| CP₍ₖ₋₁₎ | k |

.
.
.

The energy transformation models utilized for a particular input image can be variously selected. In one instance, the energy transformation models selected and utilized is based on the imaging protocol used to acquire the input image. For example, where the imaging protocol is for a contrast-agent enhanced scan to rule out or follow up on a soft tissue tumor or lesion, the protocol may indicate a target energy for a particular material class corresponding to the soft tissue that would visually enhance contrast agent uptake in the tumor. Additionally, or alternatively, rules stored with the energy transformation models are utilized to select the energy transformation models. Additionally, or alternatively, a user input selects the energy transformation model. Additionally, or alternatively, AI suggests the energy transformation model.

In one instance, the input image energy is in terms of the kVp, and the target image energy is in terms of the keV. In another instance, the input image energy is in terms of kVp, the kVp is converted to an approximate keV equivalent, and the target image energy is in terms of the keV. For example, it has been empirically shown that a 120 kVp image is approximately equivalent to a 70 keV, e.g., as discussed in Krishna et al., “Attenuation and Degree of Enhancement With Conventional 120-kVp Polychromatic CT and 70-keV Monochromatic Rapid Kilovoltage-Switching Dual-Energy CT in Cystic and Solid Renal Masses,” AJR Am J Roentgenol 2018; 211:789-96, and/or Cui et al., “Which should be the routine cross-sectional reconstruction mode in spectral CT imaging: monochromatic or polychromatic?,” Br J Radiol. 2012; 85 (1018): e887-90, and/or otherwise. As such, an energy transformation model can be in terms of kVp to keV and/or keV to keV.

Where energy transformation models are stored (e.g., the energy transformation models 206 of FIG. 2), an energy transformation model can be selected and utilized based at least one of the energy of the input image and the target energy of the output image. In one instance, an energy transformation model can be generated for all available target energies. In another instance, an energy transformation model can be derived, e.g., via interpolation, extrapolations, and/or other approach from other energy transformation models. Where distributions are stored, energy transformation models can be generated on-demand, e.g., depending on the energy of the input image and the target energy of the output image.

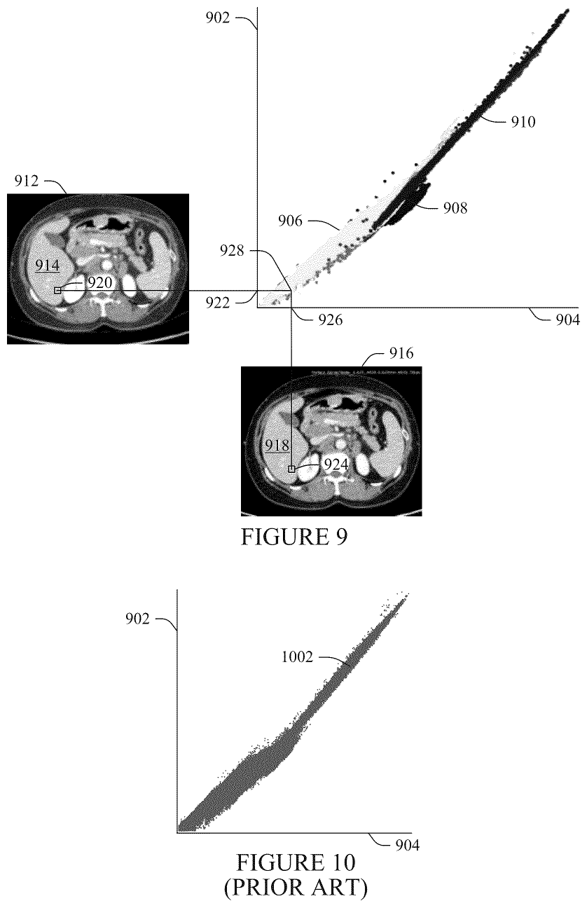

FIGS. 9, 11, 12, 13, 14, 15 and 16 illustrate distributions for the different approaches described herein, including distributions for multiple material classes, multiple material sub-classes, and/or multiple contrast phases.

In initially referring to FIG. 9, non-limiting example distributions for generating transformation models for multiple material classes from pairs of two different energy images is graphically illustrated. A first axis 902 represents CT numbers in images for one of the energies. A second axis 904 represents CT numbers in images for the other energy. For both of the axes 902 and 904, the CT numbers increase in a direction away from the origin. As described herein, the images are segmented by material class, and the distribution algorithm 804 (FIG. 8) determines a joint distribution for each material class. The graph includes joint distributions for N material classes (where N is a positive integer), including a first joint distribution 906 for first material class, . . . , an ith joint distribution 908 for an ith material class, . . . , and an nth joint distribution 910 for an nth material class.

The different joint distribution 906, . . . , 908, . . . , and 910 are visually presented using different gray scale values. For example, a first gray scale value represents the first joint distribution 906, an ith gray scale value represents the ith joint distribution 908, . . . , and an nth gray scale value represents the nth joint distribution 910. The shapes, slopes and extents (CT number range) of the joint distributions 906, . . . , 908, . . . , and 910 vary between the illustrated different material classes such that fitting a single model to the aggregate of the joint distributions 906, . . . , 908, . . . , and 910 does not provide a model that fits well to any of the individual joint distributions 906, . . . , 908, . . . , and 910, and, hence, is not well-suited for any of the individual material classes. Other visual indicia such as color, pattern, transparency/opaqueness, etc. could alternatively (or additionally) be utilized to visually show the different distributions.

The joint distributions 906, . . . , 908, . . . , and 910 represent mappings between pairs of images of the two different energies. By way of non-limiting example for a particular pair of images and material class, a first energy image 912 is segmented (e.g., via the tissue segmentation module 202 (FIG. 2) and/or otherwise) and at least includes a first segmented anatomy 914, and a second energy image 916 is segmented (e.g., via the tissue segmentation module 202 (FIG. 2) and/or otherwise) and at least includes a second segmented anatomy 918, where the first and second segmented anatomies 914 and 918 represents a same anatomy (i.e., the liver in FIG. 9).

A first CT number, which represents a first set of pixels in a first region of interest (ROI) 920 in the segmented anatomy 914 in the first energy image 912, is mapped to a corresponding CT number 922 on the first axis 902, and a second CT number, which represents a second set of pixels in a second ROI 924 in the second segmented anatomy 918 in the second energy image 916, is mapped to a corresponding CT number 926 on the first axis 902. The first and second ROIs 920 and 924 are a same size and positioned at a same x,y or x,y,z location in the two energy images 912 and 916, and, hence, represent a same material in the two different energy images 912 and 916.

An intersection 928 of the CT numbers 922 and 926 provide a point in the first distribution 906. The first distribution 906 includes intersection points from multiple different ROI pairs in the segmented anatomy 914 in the first energy image 912 and the second segmented anatomy 918 in the second energy image 916. The other joint distributions . . . , 908, . . . , and 910 likewise include intersection points from multiple different ROI pairs in the segmented anatomy in the first and second energy images 912 and 916 for respective material classes. The fitting algorithm 806 fits a curve to each of the joint distributions 906, . . . , 908, . . . , and 910 respectively to generate an energy transformation model for each corresponding material class in the segmentation masks.

FIG. 10 shows a prior art example described in connection with FIG. 9 where the different material classes are not considered by the distribution algorithm 804 (FIG. 8). As a consequence, the distribution algorithm 804 generates a single distribution 1002 for all of the different material classes in the energy images 912 and 916, regardless of differences amongst energy based attenuation differences, and the shape, slope and extent of the single distribution 1002 does not well represent any of the individual joint distributions 906, . . . , 908, . . . , and 910 (FIG. 9). As a consequence, the single energy transformation model fitted to the single distribution 1002 will be less accurate for the individual tissue classes relative to the individual transformation models fitted to the individual joint distributions 906, . . . , 908, . . . , and 910.

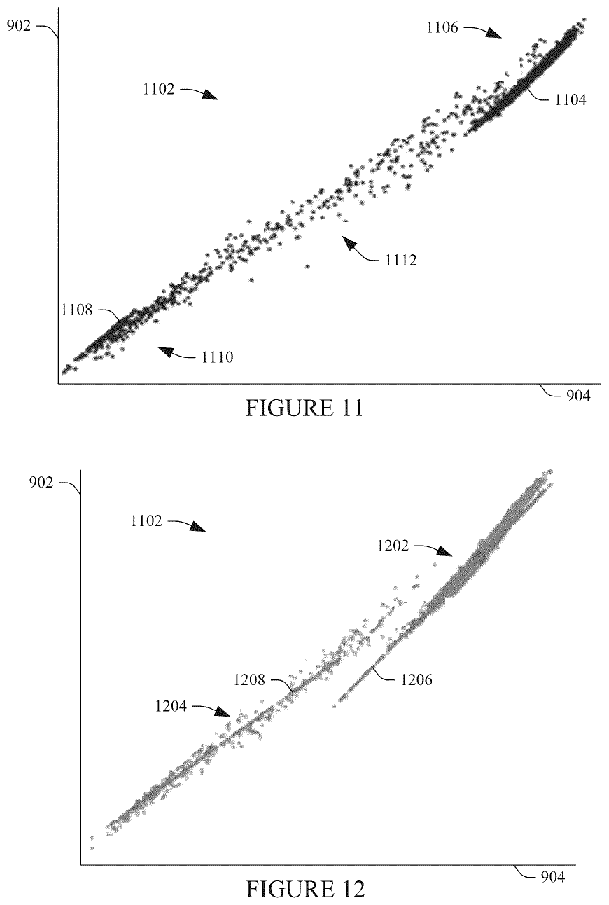

FIGS. 11 and 12 describe an example in which a single material class is further delineated into material sub-classes. FIG. 11 graphically illustrates a joint distribution 1102 for a single material class for a pair of energy images. The joint distribution 1102 includes a first denser region 1104 at a first end 1106 and a second denser region 1108 at a second opposing end 1110 with a less dense region 1112 between the first end 1106 and the second opposing end 1110. FIG. 12 graphically illustrates the joint distribution 1102 for the single material class for a plurality of pairs of energy images. In FIG. 12, multiple joint distributions for the same material classes from different examinations are aggregated.

In this example, the images selected for generating and combining distribution are the images that best represent each of the material sub-classes in the first denser region 1104 and the second denser region 1108 (FIG. 11). For example, the images selected may include images with distributions reflecting a greater density for the first region 1104 and images with distributions reflecting a greater density for the second region 1108. In this example, the distribution 1102, after the aggregation of the distributions from the multiple imaging examinations, is clustered and split into multiple sub-distributions, including a first sub-distribution 1202 and a second sub-distribution 1204. The first sub-distribution 1202 represents a first sub-class of the material class, and the second sub-distribution 1204 represents a second sub-class of the material class.

The fitting algorithm 806 (FIG. 8) fits a curve to each of the first sub-distribution 1202 and the second sub-distribution 1204. In FIG. 12, the fitting algorithm 806 fits a first curve 1206 to the first sub-distribution 1202 and fits a second curve 1208 to the second sub-distribution 1204. As illustrated, in this example slopes of the first and second curves 1206 and 1208 are different (and different from a slope of a curve that would fit the distribution 1102 (FIG. 11)), better representing the different varying non-linear attenuation characteristics of the different sub-tissue classes relative to not considering the material sub-classes. An example of such a material class is the stomach, with material sub-classes including a wall and air. Another example of such a material class is the liver, with material sub-classes including vessels and parenchyma. Other material classes that include sub-classes are also contemplated herein.

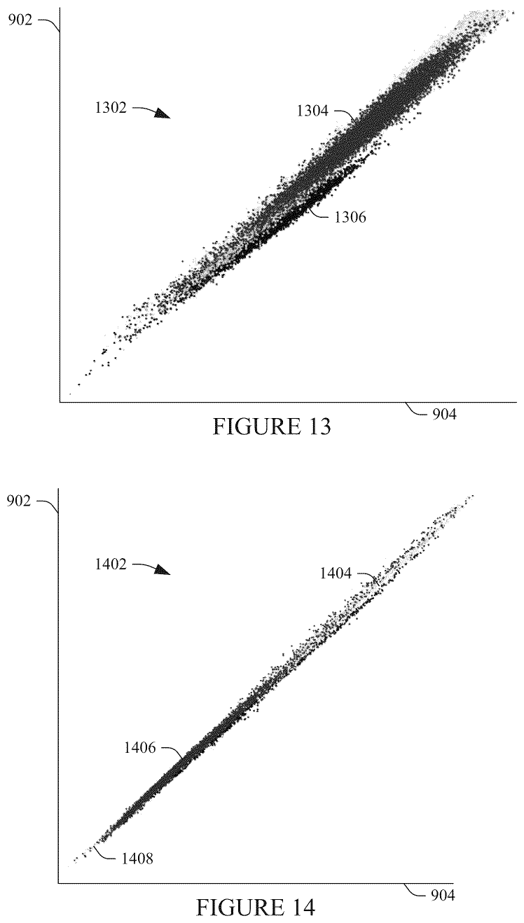

FIGS. 13 and 14 graphically illustrate an example in which a single material class is further delineated based on contrast phase. In FIG. 13, a joint distribution 1302 represents a single distribution for a single material class. The joint distribution 1302 is further delineated into multiple joint sub-distributions, including a first joint sub-distribution 1304 for a first contrast phase and a second joint sub-distribution 1306 for a second contrast phase. The fitting algorithm 806 (FIG. 8) can fit a curve to the joint distribution 1302, a curve to the first joint sub-distribution 1304, and a curve to the second joint sub-distribution 1306, and/or a combination thereof.

In FIG. 14, a joint distribution 1402 represents a single distribution for a single material class. The joint distribution 1402 is further delineated into multiple joint sub-distributions, including a first joint sub-distribution 1404 for a first contrast phase, a second joint sub-distribution 1406 for a second contrast phase, and a third joint sub-distribution 1408 for a third contrast phase. The fitting algorithm 806 (FIG. 8) can fit a curve to the joint distribution 1402, a curve to the first joint sub-distribution 1404, a curve to the second joint sub-distribution 1406 and a curve to the third joint sub-distribution 1408, and/or a combination thereof.

With reference to FIGS. 13 and 14, in one instance, the material class represented in FIG. 13 is more vascular than the material class represented in FIG. 14. An example of such materials is kidney versus vertebrae. The kidney are more vascular than the vertebrac. As such, the different contrast phases are more pronounced in the kidney. As a result, and with continuing reference to FIGS. 13 and 14, slopes fitted to the distributions 1304 and 1306 will be more different than slopes fitted to the distributions 1404 and 1406. As such, employing energy transformations specific to a material class and the contrast phases for the material class will better represent the attenuation transformation between the input image and targe image energy levels.

FIGS. 13 and 14 each show multiple contrast phases of a single material class.

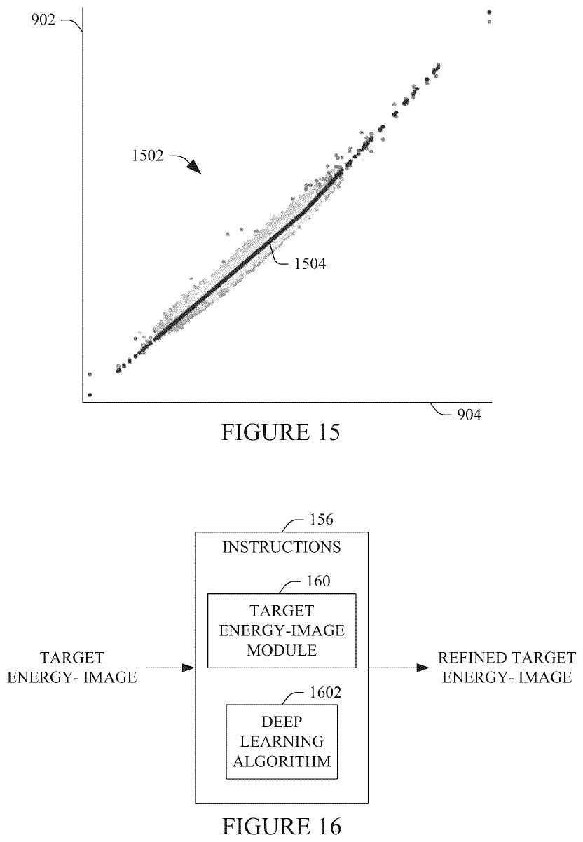

FIG. 15 graphically illustrates a distribution 1502 of a single contrast phase for a single material class over multiple imaging examinations. FIG. 15 further shows a curve 1504 fitted to the distribution 1502. Similarly, the distribution 1502 can be generated by the distribution algorithm 804 (FIG. 8) and/or otherwise, and the curve 1504 can be fitted to the distribution 1502 by the fitting algorithm 806 (FIG. 8) and/or otherwise. Another variation includes a combination of the examples described in connection with FIGS. 9, 11, 12, 13, 14 and 15.

FIG. 16 schematically illustrates another variation. In this example, the instructions 156 (as part of the energy transformation generating module 802 (FIG. 8) or separate therefrom) further includes a deep learning algorithm 1602. The deep learning algorithm 1602 receives, as input, the output target energy-image. The deep learning algorithm 1602 employs a deep learning (DL) algorithm on the output target energy-image. The deep learning algorithm 1602 outputs a refined deep output target energy-image.

As utilized herein, a deep learning refers to an AI, machine learning, etc. algorithm with multiple layers in the network and can be supervised, semi-supervised, or unsupervised. Examples of suitable deep learning include, but are not limited to, Convolutional Neural Networks (CNNs), Long Short Term Memory Networks (LSTMs), Recurrent Neural Networks (RNNs), Generative Adversarial Networks (GANs), Radial Basis Function Networks (RBFNs), Multilayer Perceptrons (MLPs), Self-Organizing Maps (SOMs), Deep Belief Networks (DBNs), Restricted Boltzmann Machines (RBMs), and Autoencoders (AE).

Generally, a DL model in and of itself is not well-suited to be applied to the input image, e.g., where a difference between the energy of the input image and the target energy exceeds a pre-determined threshold level at least because the varying non-linear attenuation characteristics of each material type cannot be captured in one step or one DL model, as it degenerates to a many-to-many mapping. However, the approach described herein is material class/sub-class specific, leading to a material class and/or material sub-class mapping, enabling transformation across wide variation of input and target energies.

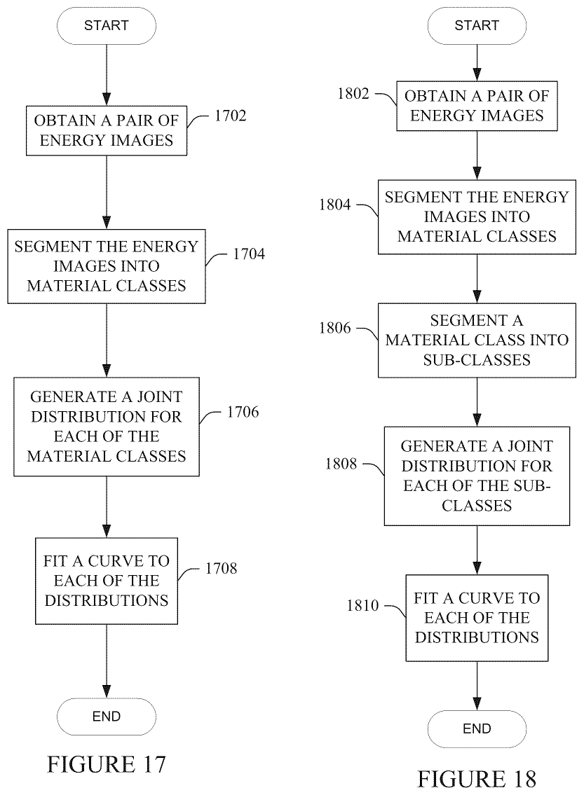

FIGS. 17, 18 and 19 illustrate non-limiting examples of flow charts for a computer-implemented method for generating energy transformation models. It is to be appreciated that the ordering of the acts in one or more of the methods is not limiting. As such, other orderings are contemplated herein. In addition, one or more acts may be omitted, and/or one or more additional acts may be included.

FIG. 17 illustrates a non-limiting example for generating energy transformation models for different material classes. At 1702, a pair of different energy images is obtained, as described herein and/or otherwise. At 1704, the pair of different energy images are segmented to generate masks of material classes in the different energy images, as described herein and/or otherwise. At 1706, a joint distribution is generated for each material class based on the masks, as described herein and/or otherwise. At 1708, a curve is fit to each distribution, generating an energy transformation model for each of the material classes represented by the distributions, as described herein and/or otherwise. The models are stored and/or utilized, as described herein and/or otherwise.

FIG. 18 illustrates a non-limiting example for generating energy transformation models for different material classes and material sub-classes. At 1802, a pair of different energy images is obtained, as described herein and/or otherwise. At 1804, the pair of different energy images is segmented to generate masks of material classes. At 1806, at least one material class in the mask is segmented to generate masks of material sub-classes. At 1808, a joint distribution is generated for each material sub-class of the material class, as described herein and/or otherwise. At 1810, a curve is fit to each distribution, generating an energy transformation model for each of the material sub-classes, as described herein and/or otherwise. The models are stored and/or utilized, as described herein and/or otherwise.

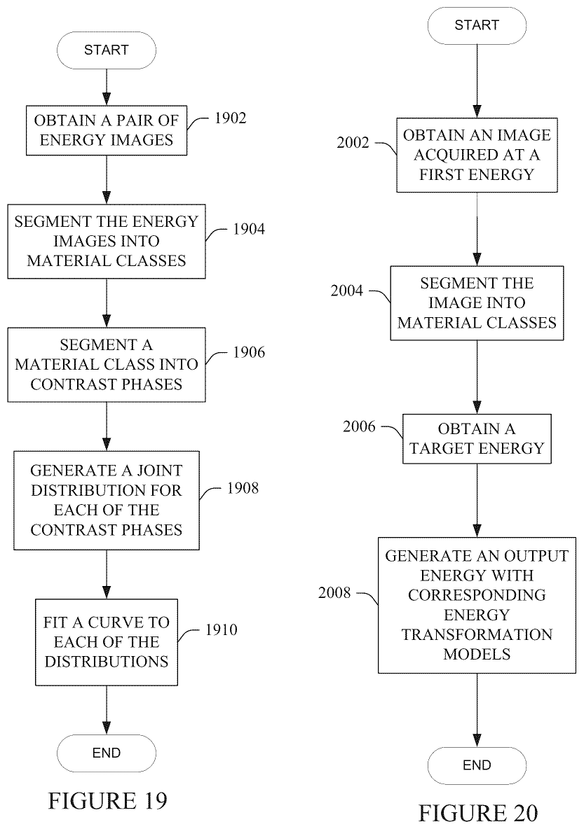

FIG. 19 illustrates a non-limiting example for generating energy transformation models for different contrast phases of a material classes. At 1902, a pair of different energy images is obtained, as described herein and/or otherwise. At 1904, the pair of different energy images is segmented to generate masks of material classes, as described herein and/or otherwise. At 1906, the masks are further delineated into contrast phases for at least one material class, as described herein and/or otherwise. At 1908, a joint distribution is generated for each contrast phase of a material class, as described herein and/or otherwise. At 1910, a curve is fit to each distribution, generating an energy transformation model for each of the contrast phases of a material class, as described herein and/or otherwise. The models are stored and/or utilized, as described herein and/or otherwise.

FIGS. 20, 21 and 22 illustrate non-limiting examples of flow charts for a computer-implemented method for employing energy transformation models for different material classes. It is to be appreciated that the ordering of the acts in one or more of the methods is not limiting. As such, other orderings are contemplated herein. In addition, one or more acts may be omitted, and/or one or more additional acts may be included.

FIG. 20 illustrates a non-limiting example for employing energy transformation models for different material classes. At 2002, an input image corresponding to an acquisition energy is obtained, as described herein and/or otherwise. At 2004, the input image is segmented to generate a mask of material classes in the input image, as described herein and/or otherwise. At 2006, a target energy is obtained, as described herein and/or otherwise. At 2008, an output image at the target energy is generated for a plurality of material classes based on the energy of the input image, the target energy, the segmentation mask, and energy transformation models corresponding to the energy of the input image and the target energy, as described herein and/or otherwise.

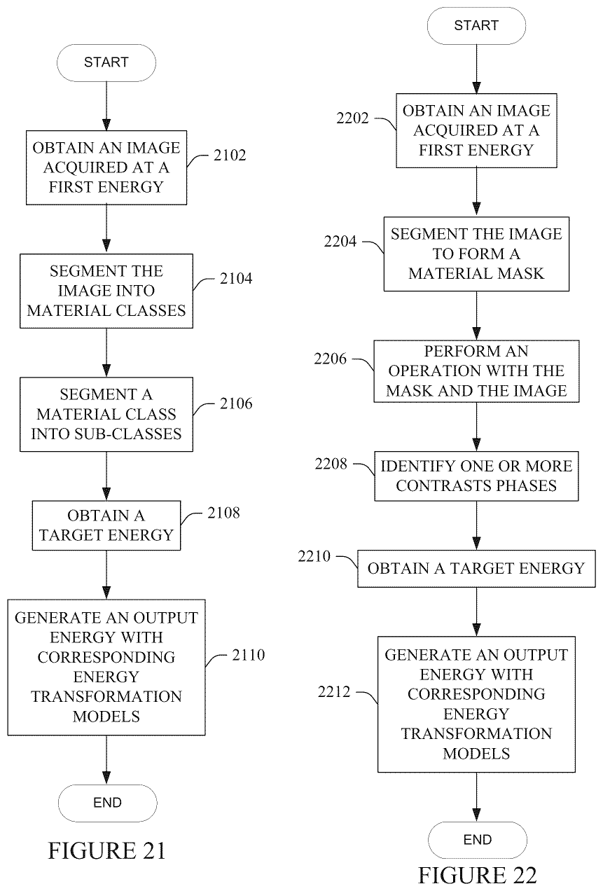

FIG. 21 illustrates another non-limiting example for employing energy transformation models for different material classes and material sub-classes. At 2102, an input image corresponding to an acquisition energy is obtained, as described herein and/or otherwise. At 2104, the input image is segmented to generate a mask of material classes in the input image, as described herein and/or otherwise. At 2106, at least one material class in the mask is segmented into material sub-classes, as described herein and/or otherwise. At 2108, a target energy is obtained, as described herein and/or otherwise. At 2110, an output image at the target energy is generated for each of the material sub-classes, as described herein and/or otherwise.

FIG. 22 illustrates another non-limiting example for employing energy transformation models for different contrast phases of a material classes. At 2202, an input image corresponding to an acquisition energy is obtained, as described herein and/or otherwise. At 2204, the input image is segmented to generate a mask of material classes in the input image, as described herein and/or otherwise. At 2206, the mask and the input image are operated on, as described herein and/or otherwise. At 2208, one or more contrast phases are identified based on the output of the operation, as described herein and/or otherwise. At 2210, a target energy is obtained, as described herein and/or otherwise. At 2212, an output image at the target energy is generated based on the output of the operation, the identified one or more contrast phases and one or more corresponding transformation models, as described herein and/or otherwise.

The above may be implemented by way of computer readable instructions, encoded or embedded on computer readable storage medium (which excludes transitory medium), which, when executed by a computer processor(s) (e.g., CPU, microprocessor, etc.), cause the processor(s) to carry out acts described herein. Additionally, or alternatively, at least one of the computer readable instructions is carried by a signal, carrier wave or other transitory medium, which is not a computer readable storage medium.

As used herein, an element or step recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

Embodiments of the present disclosure shown in the drawings and described above are example embodiments only and are not intended to limit the scope of the appended claims, including any equivalents as included within the scope of the claims. Various modifications are possible and will be readily apparent to the skilled person in the art. It is intended that any combination of non-mutually exclusive features described herein are within the scope of the present disclosure. That is, features of the described embodiments can be combined with any appropriate aspect described above and optional features of any one aspect can be combined with any other appropriate aspect. Similarly, features set forth in dependent claims can be combined with non-mutually exclusive features of other dependent claims, particularly where the dependent claims depend on the same independent claim. Single claim dependencies may have been used as practice in some jurisdictions that require them, but this should not be taken to mean that the features in the dependent claims are mutually exclusive.

What is claimed is:

1. A computed tomography imaging system, comprising:
an X-ray source configured to emit X-ray radiation that traverses a subject being imaged;
an X-ray controller configured to control an energy applied to the X-ray source;
an X-ray radiation sensitive detector array disposed opposite the X-ray source, and configured to detect X-ray radiation traversing the subject, generating signals indicative of the detected X-ray radiation;
a reconstructor configured to reconstruct an image based on the signals, wherein the image includes at least two material classes and corresponds to the applied energy; and
an operator console with at least one processor configured to execute a target energy-image module to generate an output image at a target energy based on the reconstructed image, the applied energy, the target energy, and material class specific energy transformation models, including a different energy transformation model for each of the at least two material classes.

2. The computed tomography imaging system of claim 1, wherein at least one of the at least two material classes include two or more material sub-classes, and the set of material class energy transformation models includes a different energy transformation model for each of the two or more material sub-classes.

3. The computed tomography imaging system of claim 1, wherein at least one of the at least two material classes includes two or more contrast phases, and the set of material class energy transformation models includes a different energy transformation model for each of the two or more contrast phases.

4. The computed tomography imaging system of claim 1, wherein the at least one processor is further configured to refine the output image at the target energy based on a deep learning algorithm.

5. The computed tomography imaging system of claim 1, wherein the at least one processor is further configured to segment the reconstructed image into the two or more material classes, generate a material class mask, and employ the material class mask to generate the output image at the target energy.

6. The computed tomography imaging system of claim 5, wherein the at least one processor is further configured to generate an reference image based on the material class mask and the reconstructed image, to estimate a contrast phase based on the segmented image, and generate the output image at the target energy based on the reference image and the estimated contrast phase.

7. The computed tomography imaging system of claim 1, wherein the predetermined target energy includes a first target energy for a first material class of the two or more material classes and a second target energy for a second material class of the two or more material classes, wherein the first target energy is different from the second target energy.

8. A computer-implemented method, comprising:
obtaining an image acquired at a first energy in a single energy CT imaging examination;
segmenting the image into a plurality of different material classes; and
generating an output image at a target energy for at least one of the material classes based on an energy transformation model corresponding to the at least one of the material classes, the first energy, and the target energy.

9. The computer-implemented method of claim 8, further comprising:
obtaining a pair of different energy images acquired during a multi-energy image acquisition;
segmenting the plurality of different material classes from each of the pair of different energy images;
determining a joint distribution for the at least one of the material classes based on the pair of different energy images and the segmented plurality of different material classes; and
generating the energy transformation model for the at least one of the materials based on the joint distribution.

10. The computer-implemented method of claim 8, wherein the at least one of the materials includes two or more material sub-classes, and the material class energy transformation model includes a different energy transformation model for each of the two or more material sub-classes.

11. The computer-implemented method of claim 10, further comprising:
obtaining a pair of different energy images acquired during a multi-energy image acquisition;
segmenting the plurality of different material classes from each of the pair of different energy images;
segmenting the two or more material sub-classes from the at least one of the materials;
determining a joint distribution for each of the two or more material sub-classes based on the pair of different energy images and the segmented two or more material sub-classes; and
generating the different energy transformation model for each of the two or more material sub-classes based on corresponding joint distribution.

12. The computer-implemented method of claim 8, wherein the at least one of the materials includes two or more contrast phases, and the material class energy transformation model includes a different energy transformation model for each of the two or more contrast phases.

13. The computer-implemented method of claim 10, further comprising:
obtaining a pair of different energy images acquired during a multi-energy image acquisition;
segmenting the plurality of different material classes from each of the pair of different energy images;
determining the two or more contrast phases for the at least one of the materials;
determining a joint distribution for each of the two or more contrast phases for the at least one of the materials based on the pair of different energy images, the segmented plurality of different material classes, and the joint distributions; and
generating the different energy transformation model for each of the two or more contrast phases for the at least one of the materials based on corresponding joint distributions.

14. The computer-implemented method of claim 8, wherein the target energy includes a first target energy for a first material class of the two or more material classes and a second target energy for a second material class of the two or more material classes, and further comprising:
generating first pixels for the first material class in the output image based on a first energy transformation model corresponding to the first material class; and
generating second pixels for the second material class in the output image based on a second energy transformation model corresponding to the second material class.

15. A computer readable medium encoded with computer executable instructions, which when executed by at least one processor, causes the at least one processor to:
obtain an image acquired at a first energy in a single energy CT imaging examination;
segment the image into at least two material classes; and
generate an output image at a target energy for at least one of the two material classes based on an energy transformation model corresponding to the at least one of the two material classes.

16. The computer readable medium of claim 15, where the instructions further cause the at least one processor:
segment the at least two material classes from each of a pair of different energy images;
determine a joint distribution for each of the at least two material classes based on the pair of different energy images; and
generate the energy transformation model corresponding to the at least one of the two material classes based on the joint distribution.

17. The computer readable medium of claim 15, where the instructions further cause the at least one processor:
segment at least one of the at least two material classes into at least two material sub-classes; and
generate the output image at the target energy for the at least one of the two material sub-classes based on an energy transformation model corresponding to the at least one of the two material sub-classes.

18. The computer readable medium of claim 17, where the instructions further cause the at least one processor:
segment the at least two material classes from each of a pair of different energy images;
segment the at least two material sub-classes from at least one of the at least two material classes;
determine a joint distribution for each of the at least two material sub-classes; and
generate the energy transformation model corresponding to the at least one of the two material sub-classes based on the joint distribution.

19. The computer readable medium of claim 15, where the instructions further cause the at least one processor:
generate a mask by segmenting at least one of the at least two material classes in the image;
generate a reference image based on the mask and the image;
estimate at least two contrast phases based on the reference image; and
generate the output image at the target energy for at least one of the at least two contrast phases based on an energy transformation model corresponding to the at least two contrast phases.

20. The computer readable medium of claim 19, where the instructions further cause the at least one processor:
segment the at least two material classes from each of a pair of different energy images;
determine the at least two contrast phases for at least one of the at least two material classes;
determine a joint distribution for each of the at least two contrast phases; and
generate the energy transformation model corresponding to at least one of the at least two contrast phase based on the joint distribution.
